(19) United States
(12) Patent Application Publication
(10) Pub. No.: US 2016/0048487 A1
(43) Pub. Date: Feb. 18, 2016

(54) FUNCTIONAL COMPONENT HISTORY TRACKING

(71) Applicant: International Business Machines Corporation, Armonk, NY (US)

(72) Inventors: Simon A.S. Briggs, Winchester (GB); James K. Hook, Eastleigh (GB); Hamish C. Hunt, Ashford (GB); Nicholas K. Lincoln, Middle Wallop (GB)

(21) Appl. No.: 14/803,604

(22) Filed: Jul. 20, 2015

(30) Foreign Application Priority Data
Aug. 12, 2014 (GB) 1414239.2

(51) Int. Cl. G06F 17/22; G06F 17/30

(52) U.S. Cl. CPC G06F 17/2288; G06F 17/30876; G06F 17/30011

(57) ABSTRACT

Version history tracking of functional components is provided. Whether a source of a functional component is known to a version history tracker is determined. If the source of the functional component is determined to be not known to the version history tracker, an automated analysis of content of the functional component is performed. If the source of the functional component is determined to be known to the version history tracker, a bifurcated version history hierarchy of the functional component is created using at least partial data transfer between at least two functional components irrespective of any metadata associated with either of the at least two functional components. A branched network of the version history for the functional component is produced. The branched network of the version history is based on at least one of the automated analysis and the bifurcated version history hierarchy.

### TECHNICAL FIELD

The present invention relates generally to the field of tracking of the history of functional components and, more particularly, to the production of a branched network of the version history for a functional component, such as a file, a method or a structured document.

### BACKGROUND OF THE INVENTION

There are currently numerous tools to enable a user to inspect a document history or to perform a comparison between different versions of a document. Whilst it is possible to use software such as Beyond Compare from Scooter Software Inc and SlickEdit® from SlickEdit Inc. to view single instance changes to data files, it would be desirable to be able to search data file changes from their current state back to their inception. Document histories can often be viewed inside the native tool within which they are developed. A user may look though previous auto-saves or previous commit versions as is the case with version control software.

These version history trackers show all changes to a document as it evolves, enabling the user to move back through the change history in a chronological order. Version history trackers highlight any changes within the contents of an entire document by doing a string comparison between the document and a previous version of that document. However, the user is restricted to seeing isolated document changes only. If two seemingly disparate sections of two different documents are the same or originate from a common origin, then this will not be visible in a version history tracker.

It would be desirable to be able to inspect changes that are restricted to a component of the document and to ignore all unrelated document changes. This is especially pertinent when the document is computer code, where a user may only be interested in the changes made to a particular method within a class or a subset of the function. It is equally applicable to other traditional components such as chapters or paragraphs within a text document.

It would further be desirable to carry out a more targeted search for document histories, to inspect changes with much more precision, timeliness and rigor. A typical problem is when changes across multiple files occur as a result of a code refactor. Typically, a user is only interested in changes in a single method of the file, which may or may not have been moved from another file.

United States Patent Application 2009/0293043 A1 discloses that in instruction sets which may be developed through many versions, groups of instructions may be changed to achieve improvements in prior versions of the instruction sets (e.g., to correct errors, to add features, or to improve compatibility with other components.) These new versions may be tracked, e.g., in a versioning tool that may record changes among versions of an instruction and may display a version of the instruction set at a particular stage of development. A development environment may store and utilize associations of a version of an instruction with observations recorded in a bug database that indicate an undesirable behavior caused by the instruction, and with notes by the developer of the version concerning the improvements to be achieved by the version as compared with other versions of the instruction. Accordingly, when a developer wishes to explore the history of an instruction (comprising one or more versions of the instruction, including the current version), the development environment may query the various sources of information about the instruction and aggregate the results into a summary of the version history of the instruction.

United States Patent Application 2012/0272151 A1 discloses a system that provides a flexible and intuitive approach for displaying and navigating the revision history of a document. A large revision history that includes hundreds of user operations may be reduced to a simple graphical representation that may be navigated by a user to visualize the revision history at finer and finer detail. A user may use tools within the system to filter or search the revision history for particular types of user operations. The hierarchical, high-level clustering algorithm also presents each of the user operations within the context of the complete revision history, allowing a user to visualize and learn various techniques for creating or modifying the content of a document. In addition, captured video content associated with the revision history may be played back to provide the user context within the application of how a document was revised. Although a more intuitive GUI for viewing version history is disclosed, it provides no knowledge of where any content has come from and is only a method of presenting data within a GUI environment.

“CoEd—A Tool for Cooperative Development of Hierarchical Documents” (1997) by Lars Bendix, Per Nygaard Larsen, Anders Ingemann Nielsen, Jesper La, Søndergaard Petersen, Fredrik Bajers Vej E, discloses the maintaining of an overview of how a document is evolving, and at the same time the maintaining of a complete version history. Traditional version control is extended by providing version control on both the entire structure of the document and its constituent parts. Although a hierarchical system is disclosed, there is no knowledge by the system of where any internal/external sources of data have come from.

“Using Version Control History to Follow the Changes of Source Code Elements”, Toth, Z., Novak, G., Ferenc, R., Siket, I., 17th European Conference on Software Maintenance and Reengineering (CSMR), 2013, pp. 319-322, discloses an algorithm which is able to follow the changes of the source code elements by using the changes of files. The algorithm alerts the user to changes made within tracked components from a specific change set. It is left to the user to infer any possible relationships there may or may not be between all methods and classes.

### SUMMARY

According to one embodiment of the present invention, a method for version history tracking of functional components is provided. The method includes: determining whether a source of a functional component is known to a version history tracker; responsive to a condition in which the source of the functional component is determined to be not known to the version history tracker, performing an automated analysis of content of the functional component; responsive to a condition in which that the source of the functional component is determined to be known to the version history tracker, creating a bifurcated version history hierarchy of the functional component using at least partial data transfer between at least two functional components irrespective of any metadata associated with either of the at least two functional components; and producing a branched network of the version history for the functional component, wherein the branched network of the version history is based on at least one of the automated analysis and the bifurcated version history hierarchy.

According to another embodiment of the present invention, a computer program product for version history tracking of functional components is provided. The computer program product comprises a computer readable storage medium and program instructions stored on the computer readable storage medium. The program instructions include: program instructions to determine whether a source of a functional component is known to a version history tracker; program instructions to determine that the source of the functional component is not known to the version history tracker and, in response: perform an automated analysis of content of the functional component; program instructions to determine that the source of the functional component is known to the version history tracker and, in response: create a bifurcated version history hierarchy of the functional component using at least partial data transfer between at least two functional components irrespective of any metadata associated with either of the at least two functional components; and program instructions to produce a branched network of the version history for one or each of the functional component and the functional component, wherein the branched network of the version history is based on at least one of the automated analysis and the bifurcated version history hierarchy.

According to another embodiment of the present invention, a computer system for version history tracking of functional components is provided. The computer system includes one or more computer processors, one or more computer readable storage media, and program instructions stored on the computer readable storage media for execution by at least one of the one or more processors. The program instructions include: program instructions to determine whether a source of a functional component is known to a version history tracker; program instructions to determine that the source of the functional component is not known to the version history tracker and, in response: perform an automated analysis of content of the functional component; program instructions to determine that the source of the functional component is known to the version history tracker and, in response: create a bifurcated version history hierarchy of the functional component using at least partial data transfer between at least two functional components irrespective of any metadata associated with either of the at least two functional components; and program instructions to produce a branched network of the version history for one or each of the functional component and the functional component, wherein the branched network of the version history is based on at least one of the automated analysis and the bifurcated version history hierarchy.

### BRIEF DESCRIPTION OF THE DRAWINGS

FIG. 1 shows a document and a computer program structure in which embodiments of the present invention may be implemented;

FIG. 2 shows a block diagram of a version history tracker according to an embodiment of the present invention;

FIG. 3 shows a component according to an embodiment of the present invention and constituent elements of the component;

FIGS. 4A and 4B show a flowchart of the evolution of a plurality of components to demonstrate usage of embodiments of the present invention;

FIG. 5 shows a component of type class including elements of history tracking according to embodiments of the present invention;

FIG. 6 shows a plurality of components of type method including elements of history tracking according to embodiments of the present invention;

FIG. 7 shows a version of the method B component of FIG. 6 which has been renamed;

FIG. 8 shows a version of a method C component;

FIG. 9 shows a version of the method E component which has been generated as a copy of the method C component of FIG. 6;

FIG. 10 shows the method E component of FIG. 9 after it has been edited;

FIG. 11 shows a version of the method C component of FIG. 6 which has been deleted;

FIG. 12 shows a version of a method C component of FIG. 6 which has been reinstated to a new class;

FIG. 13 shows a flow chart of an embodiment of a method of performing an analysis of the content of a functional component within a version history tracker according to embodiments of the present invention;

FIG. 14 shows a version of the method C component of FIG. 6 after processing by the embodiment of FIG. 13; and

FIG. 15 shows an embodiment of a method of transferring data into a version history tracker according to embodiments of the present invention.

### DETAILED DESCRIPTION

Disclosed is a method for use in a version history tracker, of tracking functional components, the functional components having content, the method comprising: determining whether the source of a functional component is known to the version history tracker; responsive to determination that the source of the functional component is not known to the version history tracker, performing an automated analysis of the content of the functional component; responsive to determination that the source of the functional component is known to the version history tracker, creating a bifurcated version history hierarchy of the functional component using partial or full data transfer from one functional component to another functional component irrespective of any metadata associated with either of the functional components; and responsive to said automated analysis and said bifurcated version history hierarchy, producing a branched network of the version history for the functional component.

Embodiments of the invention provide a method for use in a version history tracker, of tracking functional components, the functional components having content, the method comprising: determining whether the source of a functional component is known to the version history tracker; responsive to determination that the source of the functional component is not known to the version history tracker, performing an automated analysis of the content of the functional component; responsive to determination that the source of the functional component is known to the version history tracker, creating a bifurcated version history hierarchy of the functional component using partial or full data transfer from one functional component to another functional component irrespective of any metadata associated with either of the functional components; and responsive to said automated analysis and said bifurcated version history hierarchy, producing a branched network of the version history for the functional component. Embodiments of the invention have the advantage that similar functional components can be associated to create branched hierarchies from a singular unified identifier for a functional component. This has the benefit that two or more seemingly unrelated functional components can be tracked back to a single source that may or may not still exist. If the single source does not exist, embodiments of the present invention retain the identifier of the single source.

In an embodiment of the method of the present invention, said version history tracker further includes a component hierarchy history store having unique identifiers, component types and differences between versions of functional components stored therein; said performing an automated analysis of the content of the functional component includes: searching the component hierarchy history store for all unique identifiers of the same component type as the functional component to be analyzed; and using the differences between versions of the functional component to identify if the functional component corresponds to any of the functional components in the component hierarchy history store. This has the advantage that versions of deleted functional components that are no longer in the source of the functional component, such as deleted methods no longer in the source code, are available for tracking as the unique identifier for them is retained, even after they are deleted. This means that there is the ability to track functional components that have been reinstated from an external source.

In a further embodiment of a method of the present invention, said performing an automated analysis of the content of the functional component further includes: responsive the functional component corresponding to a one of the functional components in the component hierarchy history store, replacing the unique identifier of the functional component with a reference to the unique identifier of the one of the functional components in the component hierarchy history store; and updating the functional component by incorporating the version history of the corresponding one of the functional components in the component hierarchy history store. This has the advantage that, content analysis of two seemingly disparate functional components can be used to automatically suggest and/or implement version merges.

In an embodiment, said functional component is a computer program method usable within a computer program package.

In another embodiment, said functional component is a paragraph usable within a structured document.

Embodiments of the invention also provide a system for use in a version history tracker, of tracking functional components, the functional components having content, the system comprising: a hierarchy monitor, the hierarchy monitor: determining whether the source of a functional component is known to the version history tracker; responsive to determination that the source of the functional component is not known to the version history tracker, performing an automated analysis of the content of the functional component; responsive to determination that the source of the functional component is known to the version history tracker, creating a bifurcated version history hierarchy of the functional component using partial or full data transfer from one functional component to another functional component irrespective of any metadata associated with either of the functional components; and responsive to said automated analysis and said bifurcated version history hierarchy, producing a branched network of the version history for the functional component.

Embodiments of the invention also provide a computer program product for use in a version history tracker, for tracking functional components, the functional components having content, the computer program product comprising: a computer readable storage medium having computer readable program code embodied therewith, the computer readable program code adapted to perform the method described above when said program is run on a computer.

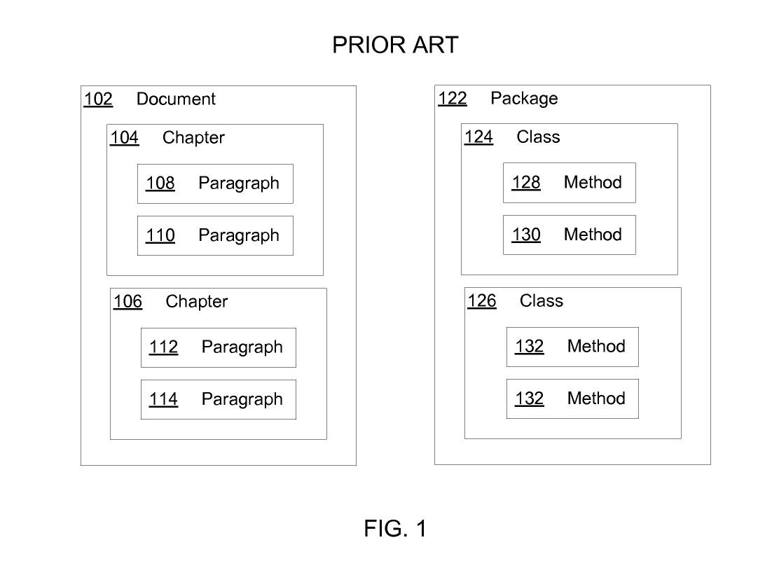

FIG. 1 shows a prior art document 102 and a prior art computer program package 122 in which embodiments of the present invention may be implemented. Document 102 includes a plurality of chapters 104, 106. Each chapter 104, 106 includes a plurality of paragraphs 108, 110, 112, 114. The paragraphs 108, 110, 112, 114 and chapters 104, 106 form a hierarchical structure under the document 102. Similarly, computer program package 122 includes a plurality of classes 124, 126. Each class 124, 126 includes a plurality of methods 128, 130, 132, 134. The methods 128, 130, 132, 134 and classes 124, 126 form a hierarchical structure under the package 122.

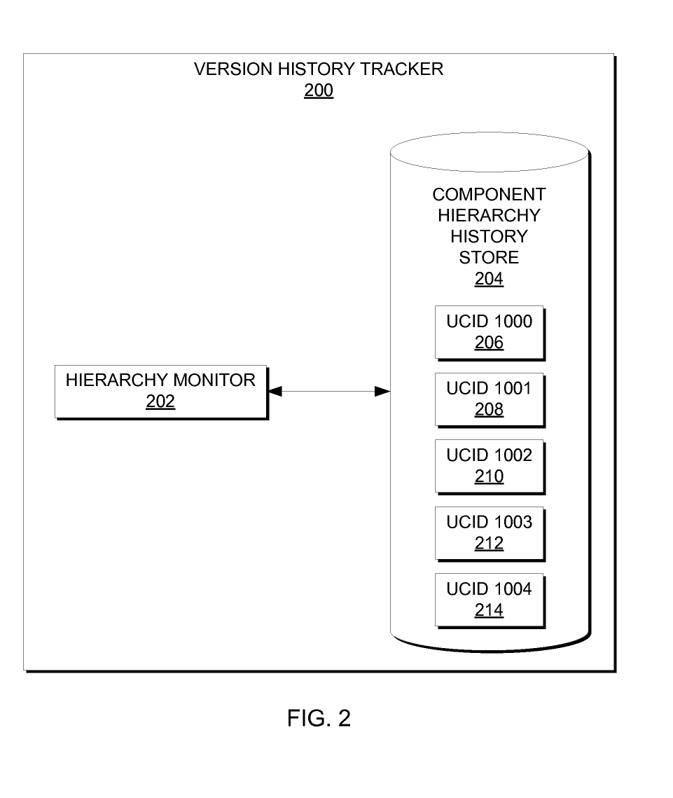

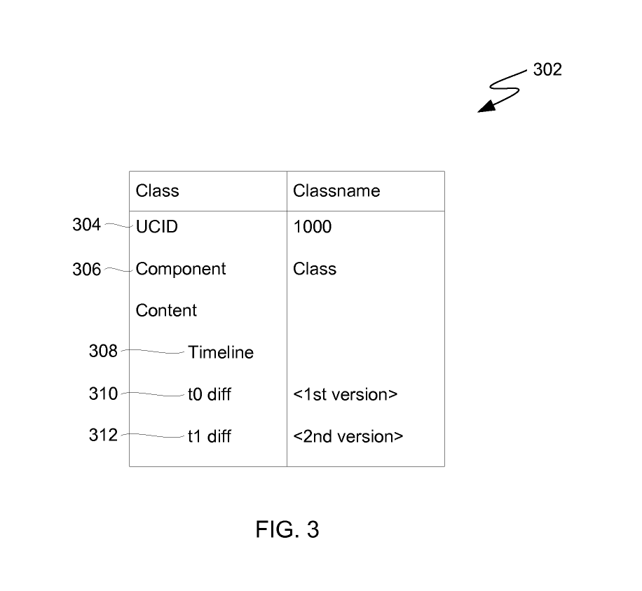

FIG. 2 shows a block diagram of a version history tracker 200 according to an embodiment of the present invention. A hierarchy monitor 202 monitors the hierarchical structure of a component hierarchy history store 204. The component hierarchy history store 204 includes entries for each components (e.g., a project, file, class, or method) 206, 208, 210, 212, 214. In this description, a components may be referred to by a Universal Component IDentifier (UCID) of the component. Further entries for other UCIDs may also be stored, but are not shown in FIG. 2 for clarity. A pointer from a UCID 206, 208, 210, 212, 214 to a related UCID 206, 208, 210, 212, 214 may be stored. A UCID 206, 208, 210, 212, 214 may be related to another UCID 206, 208, 210, 212, 214 if, for example, it is a method within the same class. Associated with each UCID 206, 208, 210, 212, 214 is a respective component 302 (see FIG. 3).

FIG. 3 shows a component 302 according to an embodiment of the present invention and constituent elements of component 302. Component 302 includes a UCID 304, which in the example of FIG. 3 is “1000”. A component hierarchy history store database 204 of UCIDs (e.g., UCID 304) is maintained and was described with reference to FIG. 2. Component 302 further includes an indication 306 of the type of component 302, which in the example of FIG. 3 is “Class”. Component 302 further includes content, which is a timeline 308 of the different versions of the component 302. In the example of FIG. 3, there are two different versions shown, a first version t0 diff 310 and a second version t1 diff 312.

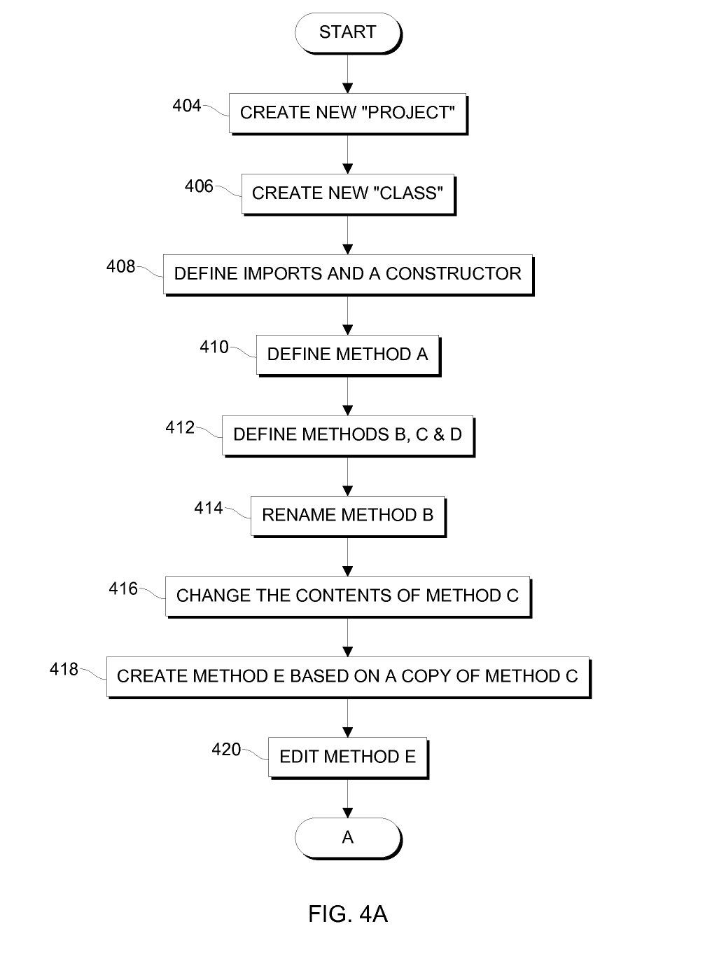

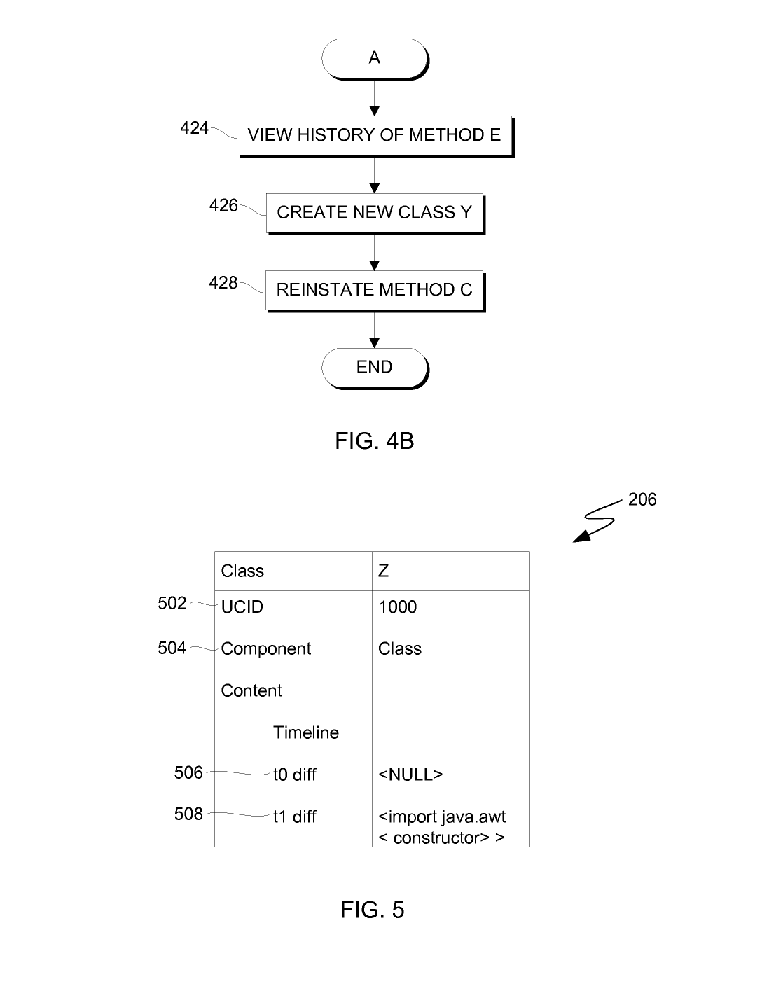

FIGS. 4A and 4B show a flow chart of an exemplary embodiment showing the evolution of a plurality of components and the history tracking of those components. The method of the exemplary embodiment is now described. At operation 404, a new “project” is started. In the exemplary embodiment, the project is a Java® project. However, embodiments of the present invention are not limited to Java projects and may be implemented in other programming languages having hierarchical constructs or in, for example, documents, such as the document of FIG. 1. Metadata for the project may be defined. The project is a component at the top of the hierarchical structure. The project contains pointers to components at the next level down in the hierarchy which are files. Each of the files contains pointers to the components at the next level down which is are classes (124, 126 in FIG. 1). Each of the classes contains pointers to the next level down which are methods (128, 130, 132, 134 in FIG. 1). The methods are at the bottom of the hierarchical structure. Each of the components (e.g., project, file, class, method) is identified by its UCID (e.g., 304 in FIG. 3).

At operation 406, a new class Z (designated 206 in FIG. 5) is created. Referring briefly to FIG. 5, components for the class Z 206 are shown. The class Z 206 is assigned a new UCID 502. The indication 504 of the type of component 206 is “Class”. The t0 diff 506 is set to blank as the class 124, 126 currently has no content. The project detects and points to the newly created UCID 502. This may be by a refresh or it may occur automatically without a refresh. At operation 408, some imports and a constructor are defined for a class Z 206. The import may be, for example, “import java.awt”. The constructor may be, for example, a standard java empty constructor, that is “public<method name>( ){ }”. The imports and the constructor are contained within the component at t1 diff 508.

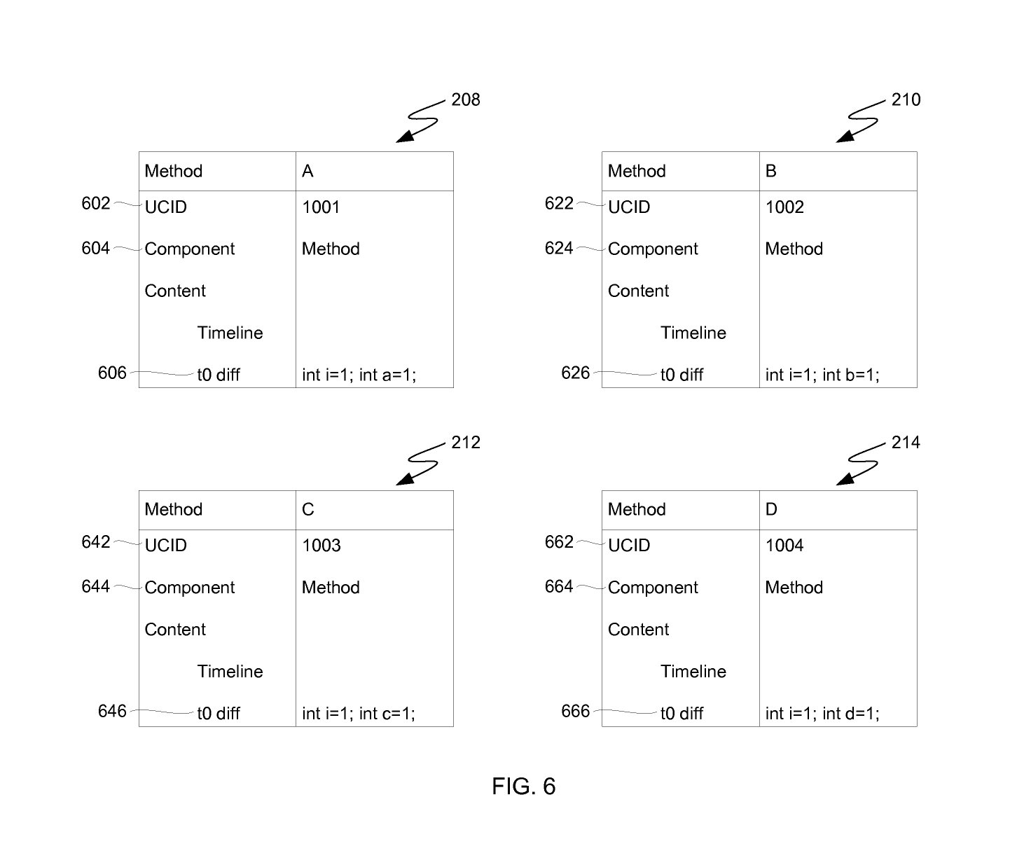

At operation 410, a method A 208 (see FIG. 6) within the class Z 206 is defined. For the purposes of this description only, the contents of method A are shown in Table 1.

TABLE 1

Method A
int i = 1;
int a = 1;

The invention is not limited to this particular content, but rather the simple content above has been chosen to allow explanation of the invention with a maximum of clarity.

Referring briefly to FIG. 6, the components for the method A 208 are shown. The method A 208 is assigned a new UCID 602 of “1001”. The component contains an identifier 604 indicating that it is of type method. The t0 diff 606 is “int i=1; int a=1;”. There is no t1 diff as there have been no changes to the method at this stage.

At operation 412, further methods B, C & D within the class Z 206 are defined in the same manner to that described above for method A 208. The components for each of these methods are shown in FIG. 6 as components 210, 212 and 214 respectively. The contents of the methods B, C & D are depicted in Table 2.

TABLE 2

| Method B | Method C | Method D |
|---|---|---|
| int i = 1; | int i = 1; | int i = 1; |
| int b = 1; | int c = 1; | int d = 1; |

The invention is not limited to this particular content for these methods, but rather the simple content above has been chosen to allow explanation of the invention with a maximum of clarity.

Referring briefly to FIG. 6, the components for the methods B 210, C 212 and D 214 are shown. The methods B 210, C 212 and D 214 are assigned new UCIDs 622, 642, 662 of 1002, 1003 and 1004 respectively. The component for the methods B 210, C 212 and D 214 contains identifiers 624, 644 and 664 respectively indicating that they are of type method. The t0 diff 626 for method B 210 is “int i=1; int b=1;”, for method C 212 the t0 diff 646 is “int i=1; int c=1;” and for method D 214 the t0 diff 666 is “int i=1; int c=1;”. There are no t1 diffs as there have been no changes to methods B 210, C 212 or D 214 at this stage.

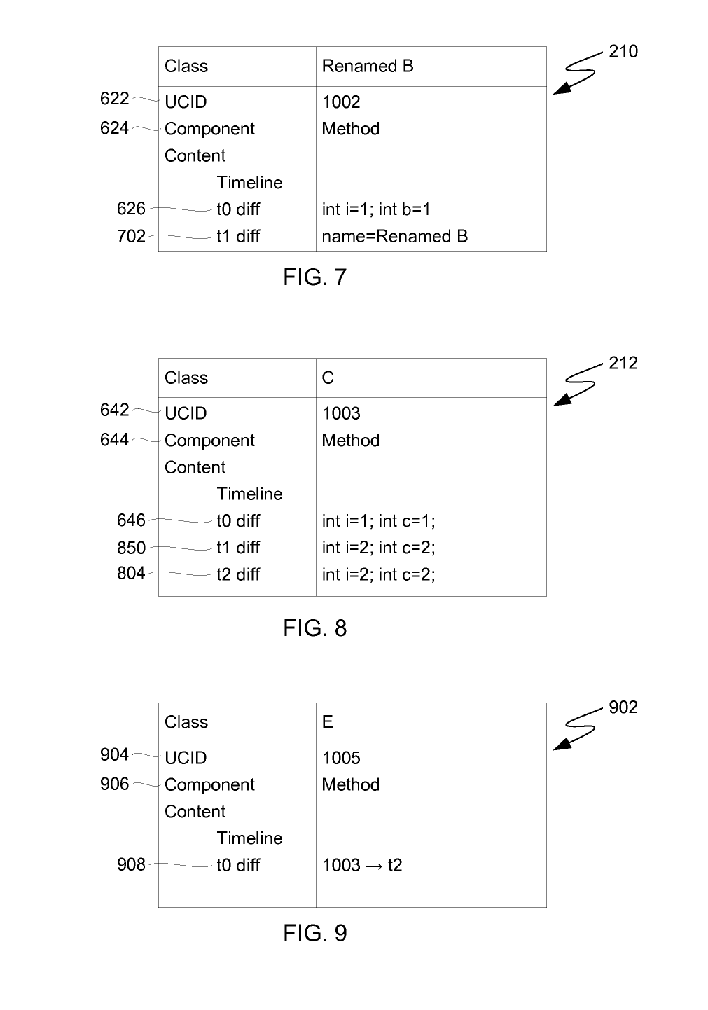

At operation 414, method B is renamed. The new method is shown in FIG. 7 as “Renamed B” 210. A new entry is created at t1 diff 702 which contains an indicator such as “name=Renamed B” within the change set. This indicator can be a field or other indicator contained within the diffs. The UCID 622 and the component type 624 are unchanged.

At operation 416, the contents of method C are changed by the user to “int i=2; int; c=2;”. Referring briefly to FIG. 8, this change is reflected at t1 in t1 diff 850. At operation 418, a new method E 902 is created based on a copy of the existing method C 212. The new method E 902 is shown in FIG. 9 as “E”. A new UCID 904 of “1005” for the method E 902 is assigned. The component type 906 “Method” for method E 902 is the same as that for method C 212. A new entry is created at t0 diff 908 which refers to the UCID 642 of “1003” for method C 212. Optionally, a forced save of method C 212 may be done at time t2 so that it is easier to see the state of method C 212 at that time of creating method E 902 based on method C 212. The state of method C 212 at t2 is shown in FIG. 8 as t2 diff 804.

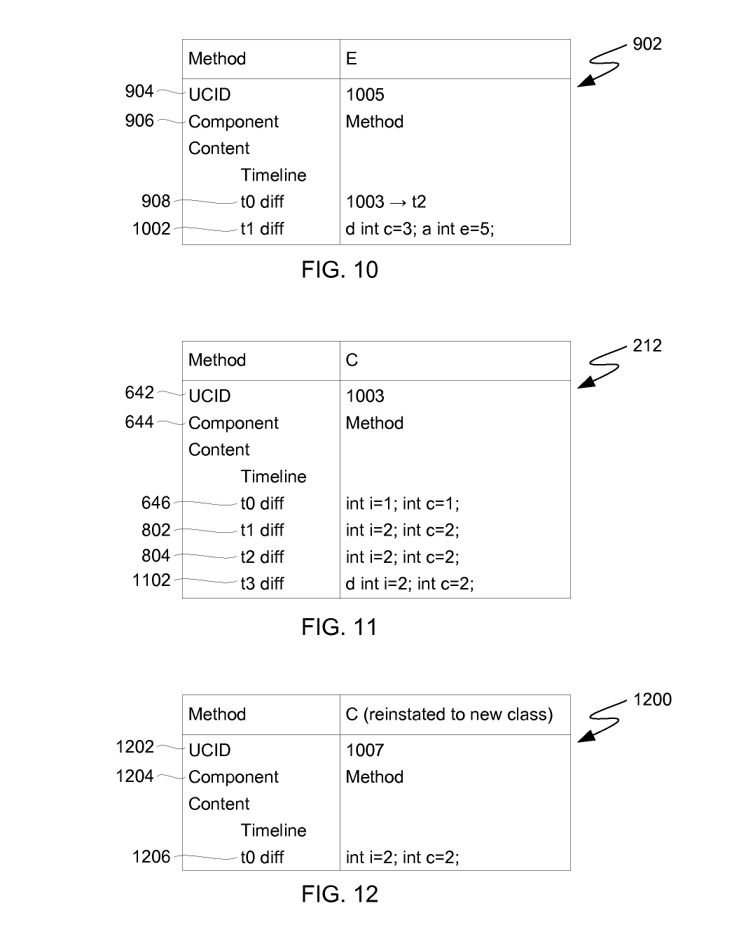

At operation 420, the method E 902 created at operation 416 is now edited to delete “int c=3;” and to add “int e=5;”. The edited method is shown in FIG. 10 as “E”. A new entry is created at t1 diff 1002. The entry of “d int c=3; a int e=5;” shows that “int c=3;” has been deleted and “int e=5” had been added.

At operation 422, the method C 212 created at operation 412 is now deleted. The deleted method is shown in FIG. 11 as “C”. A new entry is created at t3 diff 1102. The entry of “d int i=1; int c=3;” shows that “int i=1; int c=3;” has been deleted. The UCID 642 of “1003” remains in a UCID database stored in the component hierarchy history store 204.

At operation 424, the history of method E 902 is viewed. FIG. 10 shows the content of the component history for method E 902. At t1 diff 1002 is shown the most current changes to method E 902, that is “d int c=3; a int e=5”. At t0 diff 908 is shown a pointer to the UCID on which method E 902 is based, in this case a UCID of “1003”, which corresponds to method C 212. The pointer also indicates the specific diff, in this case t2, of method C 212 which method E 902 was copied from. Referring to FIG. 11 for method C 212 pointed at by t0 diff 908 of method E 902 and continuing to review the component history, t2 diff 804 for method C 212 contains a forced save copy of method C 212 at the time that method E 902 was created, that is “int i=2; int c=2;”. Further, t1 diff 850 for method C 212 contains the contents of method C 212 when it was changed at time t1, that is “int i=2; int c=2;”. Further, t0 diff 646 for method C 212 contains the contents of method C 212 when it was first created, that is “int i=1; int c=1;”. As there is no reference from method C 212 to any other UCID, then the end of the history has been reached.

In summary, the history of method E 902 when viewed in the preceding paragraph is as shown in Table 3.

TABLE 3

| | | |
|---|---|---|
| Method E | t1 diff | d int c = 3; a int e = 5 |
| Method E | t0 diff | Reference to diff t2 of UCID of method C |
| Method C | t2 diff | int i = 2; int c = 2; |
| Method C | t1 diff | int i = 2; int c = 2; |
| Method C | t0 diff | int i = 1; int c = 1; |

Note that t3 diff 1102 of method C 212 is not included in the history of method E 902 because method E 902 was created from method C 212 at a time when method C 212 was at the version documented by t2 diff 804. Subsequent to the creation of method E 902 from method C 212, method C 212 was edited and t3 diff 1102 for method C 212 created.

At operation 426, a new class Y is created in the same manner as described above at operation 406 regarding the creation of the class Z 206.

At operation 428, method C 212 is reinstated from an external source of which the history tracker has no knowledge. FIG. 12 shows the reinstated method C 1200. The UCID 1202 is initially a new UCID of “1007”. The component type 1204 is “Method”. The t0 diff 1206 is “int i=2; int c=2;”, that is the t2 diff for the deleted method C 212.

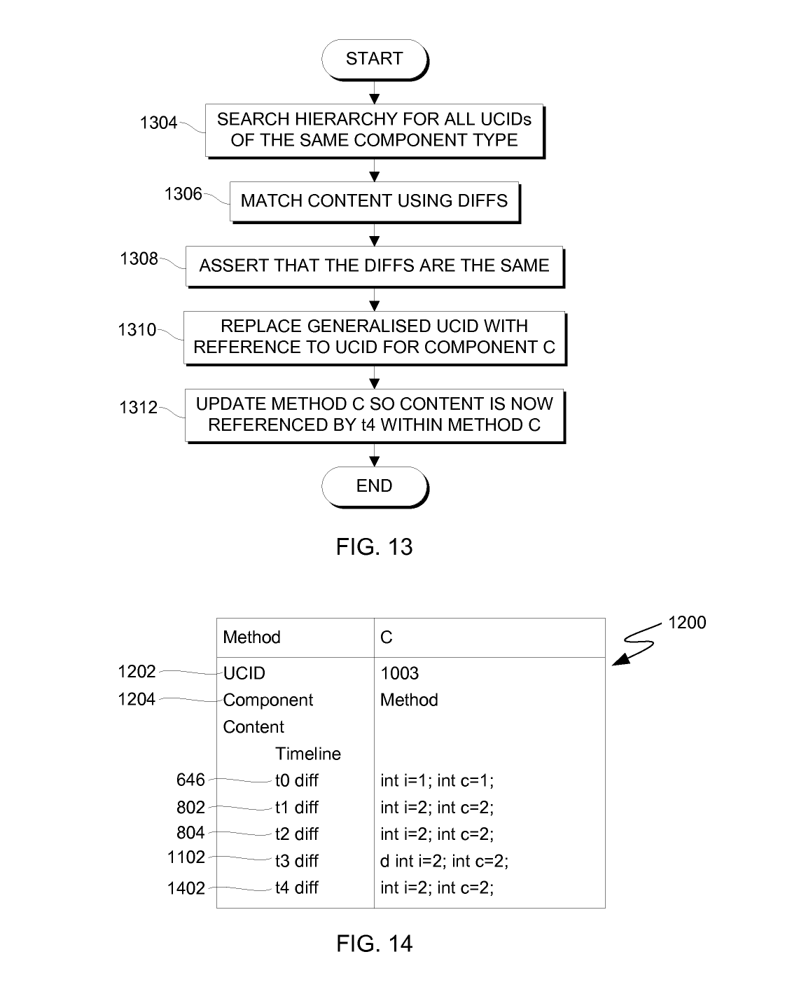

FIG. 13 shows how the version history tracker of FIG. 2 determines that the reinstated method C 1200 (see FIG. 14) corresponds to previously deleted method C 212. The method of an exemplary embodiment is now described. At operation 1304, all UCIDs 206, 208, 210, 212, 214 in the component hierarchy history store 204 of the same component type as the reinstated method C 1200 are searched. At operation 1306, the content associated with each of the UCIDs 206, 208, 210, 212, 214 is compared to the content associated with the reinstated method C 1200. When t2 diff for method 212 having a UCID of “1003” is reached, it is determined that the content of reinstated method C corresponds to original method C 212. At operation 1308, it is asserted that the diffs for method C 212 and the reinstated method C 1200 are the same. At operation 1310, the UCID 1202 of “1007” of the reinstated method C 1200 is replaced with a reference to the UCID for method C 212, that is a UCID of “1003”. At operation 1312, the t0 diff 646, the t1 diff 802, the t2 diff 804 and the t3 diff 1102 of method C 212 are added to the reinstated method C 212. The original t0 diff of the reinstated method C 1200 now becomes the t4 diff 1402 of method C 1200.

Referring to FIG. 14, the UCID 1202 of “1003” is shown, together with the t0 diff 646, the t1 diff 802, the t2 diff 804, the t3 diff 1102 and the t4 diff 1402 of method C 1200.

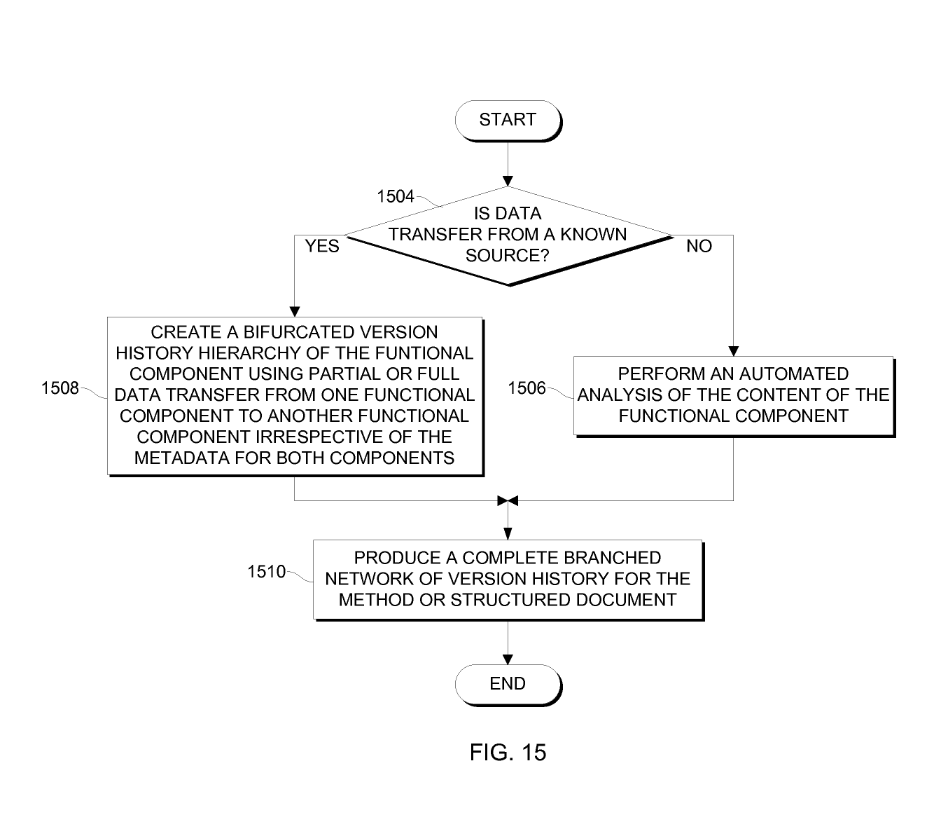

FIG. 15 shows an embodiment of a method of transferring data into a version history tracker according to embodiments of the present invention. At operation 1504 it is determined whether a data transfer into a version history tracker 200 of a functional component (e.g., paragraph 108 or method 128) is from a source known to the version history tracker 200 or from a source unknown to the version history tracker 200.

If a functional component was transferred from an unknown source, then processing passes to operation 1506. An example of a data transfer of a functional component is that of operation 428 of FIG. 4B where method C 1200 was reinstated from an external source of which the version history tracker 200 has no knowledge. At operation 1506, an automated analysis of the content of the functional component is performed. Such analysis may include the assignment of a unique UCID. An example of the automated analysis was described with reference to FIG. 13 above which resulted in the assigned UCID being replaced with the UCID for the already known method C 212.

If a functional component was transferred from a known source, then processing passes to operation 1508. At operation 1508, the UCID of the functional component is used to locate the functional component in the component hierarchy history store. A bifurcated version history hierarchy of the functional component is the created using partial or full data transfer from one functional component to another functional component. Any metadata associated with either of the functional components is ignored.

At operation 1510, a branched network of the version history of the functional component is produced using the information created by operations 1506 or 1508. Such metadata may typically include metadata to associate versions of a static object, including creation date, author and the like. Such metadata is unnecessary in embodiments of the present invention because versions of a static object can be associated by analyzing changes made to the object itself.

A particular advantage of embodiments of the present invention is that as every functional component created has a unique UCID assigned to it upon creation that is retained by the version history tracker 200 several new features are enabled. Versions of deleted functional components that are no longer in the source of the functional component, such as deleted methods no longer in the source code, are available for tracking as the UCID for them is retained, even after they are deleted. This feature gives the ability to track functional components that have been reinstated from an external source. In the case, for instance, that a functional component is deleted, is stored in an external source such as a text file and is reinstated, the analysis by the version history tracker of the system as a whole for the same functional component has the capability to reinstate this new functional component as a version of a previously deleted functional component and not just as a new functional component from some other source. This functionality is possible due to the structure and analysis stages, described above with reference to FIG. 13.

A further advantage of embodiments of the present invention is that, based on a similar argument to the above, content analysis of two seemingly disparate functional components can be used to automatically suggest and/or implement version merges.

A yet further advantage of embodiments of the present invention is that because a set of UCIDs is maintained in the component hierarchy history store, similar functional components can be associated to create branched hierarchies from a singular unified UCID. This has the advantage that two or more seemingly unrelated functional components can be tracked back to a single source that may or may not still exist. If the single source does not exist, embodiments of the present invention retain the UCID of the single source.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The term(s) “Java”, “SlickEdit”, “Smalltalk”, and the like may be subject to trademark rights in various jurisdictions throughout the world and are used here only in reference to the products or services properly denominated by the marks to the extent that such trademark rights may exist.

The term “exemplary” means of or relating to an example and should not be construed to indicate that any particular embodiment is preferred relative to any other embodiment.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for version history tracking of functional components, the method comprising:
determining whether a source of a functional component is known to a version history tracker;
responsive to a condition in which the source of the functional component is determined to be not known to the version history tracker, performing an automated analysis of content of the functional component;
responsive to a condition in which the source of the functional component is determined to be known to the version history tracker, creating a bifurcated version history hierarchy of the functional component using at least partial data transfer between at least two functional components irrespective of any metadata associated with either of the at least two functional components; and
producing a branched network of the version history for the functional component, wherein the branched network of the version history is based on at least one of the automated analysis and the bifurcated version history hierarchy.

2. The method of claim 1, wherein performing the automated analysis further comprises:
searching a component hierarchy history store for all unique identifiers of the same component type as the functional component to be analyzed, wherein the component hierarchy history store has unique identifiers, component types, and differences between versions of functional components stored in the component hierarchy history store; and
using the differences between versions of the functional component to determine whether the functional component corresponds to any of the functional components in the component hierarchy history store.

3. The method of claim 2, wherein performing the automated analysis further comprises:
responsive to determining that the functional component corresponds to at least one functional component in the component hierarchy history store, replacing the unique identifier of the functional component with a reference to the unique identifier of the corresponding at least one functional component in the component hierarchy history store; and
updating the functional component by incorporating the version history of the at least one functional component in the component hierarchy history store.

4. The method of claim 1, wherein the functional component is a portion of computer code including a program method.

5. The method of claim 1, wherein the functional component is a paragraph of a structured document.

6. A computer system for version history tracking of functional components, the system comprising:
one or more computer processors;
one or more computer readable storage media;
program instructions stored on the one or more computer readable storage media for execution by at least one of the one or more processors, the program instructions comprising:
program instructions to determine whether a source of a functional component is known to a version history tracker;
program instructions to determine that the source of the functional component is not known to the version history tracker and, in response: perform an automated analysis of content of the functional component;
program instructions to determine that the source of the functional component is known to the version history tracker and, in response: create a bifurcated version history hierarchy of the functional component using at least partial data transfer between at least two functional components irrespective of any metadata associated with either of the at least two functional components; and
program instructions to produce a branched network of the version history for the functional component, wherein the branched network of the version history is based on at least one of the automated analysis and the bifurcated version history hierarchy.

7. The computer system of claim 6, wherein the program instructions to perform the automated analysis further comprise:
program instructions to search a component hierarchy history store for all unique identifiers of the same component type as the functional component to be analyzed, wherein the component hierarchy history store has unique identifiers, component types, and differences between versions of functional components stored in the component hierarchy history store; and
program instructions to use the differences between versions of the functional component to determine whether the functional component corresponds to any of the functional components in the component hierarchy history store.

8. The computer system of claim 7, wherein the program instructions to perform the automated analysis further comprise:
program instructions to determine that the functional component corresponds to at least one functional component in the component hierarchy history store and, in response, replace the unique identifier of the functional component with a reference to the unique identifier of the at least one functional component in the component hierarchy history store; and
program instructions to update the functional component by incorporating the version history of the corresponding at least one functional component in the component hierarchy history store.

9. The computer system of claim 6, wherein the functional component is a portion of computer code including a program method.

10. The computer system of claim 6, wherein the functional component is a paragraph of a structured document.

11. A computer program product for version history tracking of functional components, the computer program product comprising:
a computer readable storage medium and program instructions stored on the computer readable storage medium, the program instructions comprising:
program instructions stored on the one or more computer readable storage media for execution by at least one of the one or more processors, the program instructions comprising:
program instructions to determine whether a source of a functional component is known to a version history tracker;
program instructions to determine that the source of the functional component is not known to the version history tracker and, in response: perform an automated analysis of content of the functional component;
program instructions to determine that the source of the functional component is known to the version history tracker and, in response: create a bifurcated version history hierarchy of the functional component using at least partial data transfer between at least two functional components irrespective of any metadata associated with either of the at least two functional components; and
program instructions to produce a branched network of the version history for the functional component, wherein the branched network of the version history is based on at least one of the automated analysis and the bifurcated version history hierarchy.

12. The computer program product of claim 11, wherein the program instructions to perform the automated analysis further comprise:
program instructions to search a component hierarchy history store for all unique identifiers of the same component type as the functional component to be analyzed, wherein the component hierarchy history store has unique identifiers, component types, and differences between versions of functional components stored in the component hierarchy history store; and
program instructions to use the differences between versions of the functional component to determine whether the functional component corresponds to any of the functional components in the component hierarchy history store.

13. The computer program product of claim 12, wherein the program instructions to perform the automated analysis further comprise:
program instructions to determine that the functional component corresponds to at least one functional component in the component hierarchy history store and, in response, replace the unique identifier of the functional component with a reference to the unique identifier of the at least one functional component in the component hierarchy history store; and
program instructions to update the functional component by incorporating the version history of the corresponding at least one functional component in the component hierarchy history store.

14. The computer program product of claim 11, wherein the functional component is a portion of computer code including a program method.

15. The computer program product of claim 11, wherein the functional component is a paragraph of a structured document.
